(19) United States
(12) Patent Application Publication
(10) Pub. No.: US 2026/0093207 A1
(43) Pub. Date: Apr. 2, 2026

(54) IMAGE FORMING APPARATUS THAT ALLOWS WIND BLOWN FROM AIR BLOWING PORT TO BE PREVENTED FROM BEING UNUNIFORM IN WIND SPEED WITHOUT INCREASING HOUSING IN SIZE

(71) Applicant: KYOCERA Document Solutions Inc., Osaka (JP)

(72) Inventor: Nobuhiro Fukuma, Osaka (JP)

(21) Appl. No.: 19/343,502

(22) Filed: Sep. 29, 2025

(30) Foreign Application Priority Data
Sep. 30, 2024 (JP) 2024-170772

(51) Int. Cl. G03G 21/20

(52) U.S. Cl. CPC G03G 21/206

(57) ABSTRACT

An image forming apparatus includes an air intake fan, a duct, and a guide portion. The air intake fan is provided at a side of a housing in a first direction. The duct includes an air blowing port that opens toward an image forming portion at a position spaced apart from the air intake fan in the direction orthogonal to the first direction, an extending portion that extends from the air intake fan to the air blowing port along a side wall portion of the housing in the first direction, and a connecting portion that connects the extending end of the extending portion and the air blowing port. The guide portion guides part of airflow into the connecting portion to the upstream side of the air blowing port in the extending direction of the extending portion.

### INCORPORATION BY REFERENCE

This application is based upon and claims the benefit of priority from the corresponding Japanese Patent Application No. 2024-170772 filed on September 30, 2024 the entire contents of which are incorporated herein by reference.

### BACKGROUND

This disclosure relates to an image forming apparatus.

A known image forming apparatus air-cools an image forming portion that forms an image on a conveyed sheet.

For example, the image forming apparatus of this type includes an air intake fan and a duct. The air intake fan is provided on a side wall portion of a housing that stores the image forming portion. The side wall portion is located in a first direction along a width direction orthogonal to the conveyance direction of the sheet. The duct guides air drawn in from the outside of the housing by the air intake fan to the image forming portion. The duct includes an air blowing port, an extending portion, and a connecting portion. The air blowing port opens toward the image forming portion at a position located further in the first direction than the image forming portion and spaced apart from the air intake fan in the direction orthogonal to the first direction. The extending portion extends from the air intake fan to the air blowing port along the side wall portion. The connecting portion connects the extending end of the extending portion and the air blowing port.

### SUMMARY

An image forming apparatus according to this disclosure includes an image forming portion, a housing, an air intake fan, a duct, and a guide portion. The image forming portion is configured to form an image on a conveyed sheet. The housing is configured to store the image forming portion. The air intake fan is configured to be provided at a side of the housing in a first direction along a width direction orthogonal to a conveyance direction of the sheet. The duct includes an air blowing port, an extending portion, and a connecting portion. The air blowing port opens toward the image forming portion in the first direction and spaced apart from the air intake fan in a direction orthogonal to the first direction. The extending portion extends from the air intake fan to the air blowing port along a side wall portion of the housing in the first direction. The connecting portion connects an extending end of the extending portion and the air blowing port. The duct is configured to guide air drawn in from outside of the housing by the air intake fan to the image forming portion. The guide portion is configured to be provided in the connecting portion and guide part of airflow into the connecting portion to an upstream side of the air blowing port in an extending direction of the extending portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view of an external configuration of an image forming apparatus according to an embodiment of this disclosure.

FIG. 2 is a cross-sectional view of an internal configuration of the image forming apparatus according to the embodiment of this disclosure.

FIG. 3 is a perspective view of a configuration of an air-cooling portion of the image forming apparatus according to the embodiment of this disclosure.

FIG. 4 is a perspective view of the configuration of the air-cooling portion of the image forming apparatus according to the embodiment of this disclosure.

FIG. 5 is a perspective view of a configuration of a third duct of the image forming apparatus according to the embodiment of this disclosure.

FIG. 6 is a perspective view of a configuration of a first forming member of the image forming apparatus according to the embodiment of this disclosure.

FIG. 7 is a perspective view of a modification of the third duct of the image forming apparatus according to the embodiment of this disclosure.

FIG. 8 is a perspective view of a modification of the third duct of the image forming apparatus according to the embodiment of this disclosure.

### DETAILED DESCRIPTION

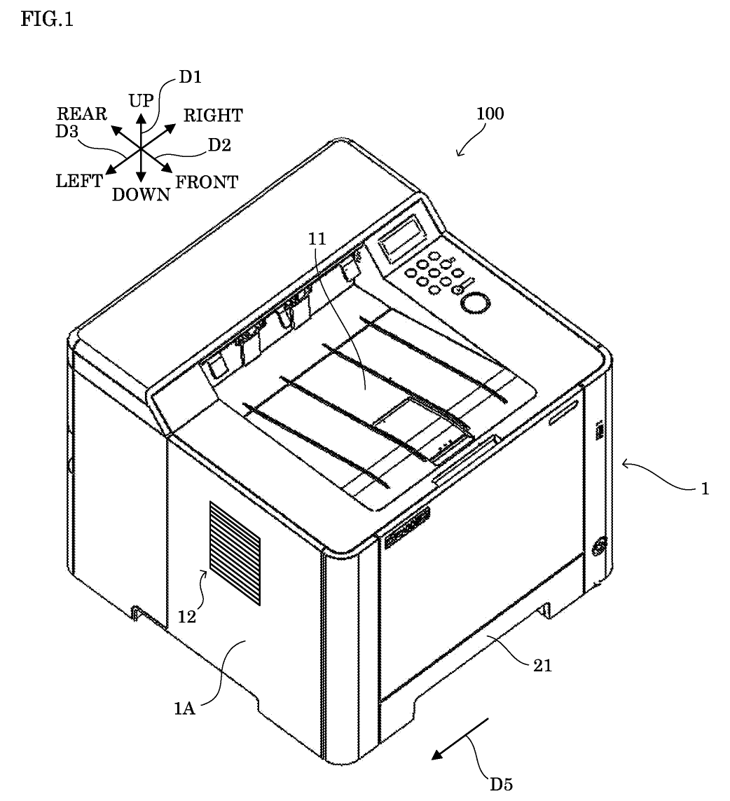

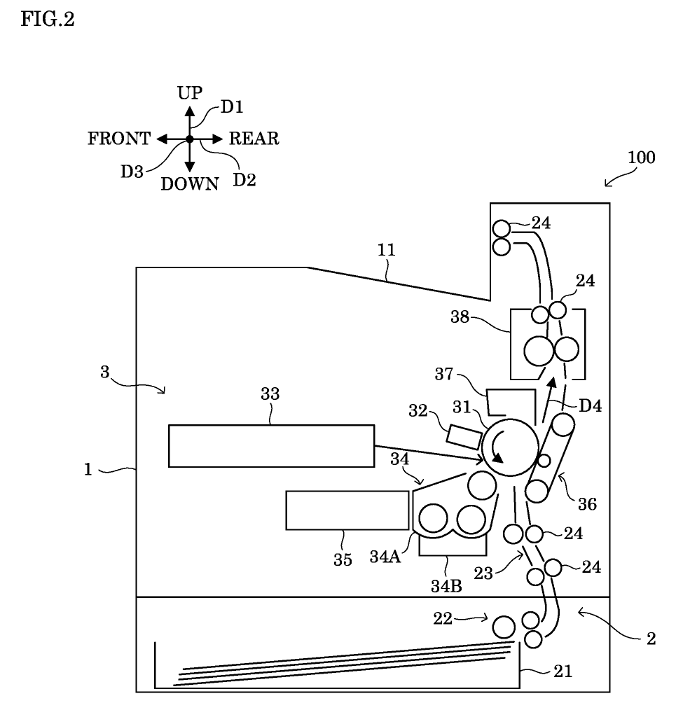

Hereinafter, an embodiment of this disclosure will be described with reference to the accompanying drawings. It is noted that the following embodiment is a specific example of this disclosure and does not limit the technical scope of this disclosure.

[Configuration of Image Forming Apparatus 100] First, the configuration of an image forming apparatus 100 according to the embodiment of this disclosure will be described with reference to FIGS. 1 and 2.

It is noted that the perpendicular direction viewed with the image forming apparatus 100 placed in an installation state (state shown in FIG. 2) that allows the image forming apparatus 100 to be used is defined as an up-down direction D1 for the convenience of description. In addition, a front-rear direction D2 is defined using the surface of the image forming apparatus 100 shown in FIG. 2 corresponding to the left of FIG. 2 as a front (front surface). Furthermore, a left-right direction D3 is defined on the basis of the front of the image forming apparatus 100 in the installation state.

The image forming apparatus 100 is a printer having a print function of forming an image on a sheet. Specifically, the image forming apparatus 100 forms an image on a sheet by electrophotography. It is noted that the image forming apparatus 100 may form an image on a sheet in an image forming method such as an inkjet method different from electrophotography. In addition, the image forming apparatus according to this disclosure is not limited to a printer. It is sufficient if the image forming apparatus according to this disclosure is any apparatus having the printing function.

As shown in FIGS. 1 and 2, the image forming apparatus 100 includes a housing 1, a sheet conveying portion 2, and an image forming portion 3.

The housing 1 stores components of the image forming apparatus 100 including the image forming portion 3.

As shown in FIG. 1, the housing 1 is substantially formed in the shape of a rectangular cuboid. The upper surface portion of the housing 1 is provided with a sheet discharge tray 11 (see FIG. 1) to which a sheet on which an image is formed is discharged. Of the four side wall portions of the housing 1, a left side wall portion 1A (see FIG. 1) located on the left side is provided with an air intake port 12 (see FIG. 1) that draws in outside air.

The sheet conveying portion 2 conveys a sheet on which an image is formed.

As shown in FIG. 2, the sheet conveying portion 2 includes a sheet feed cassette 21, a sheet feed portion 22, a sheet conveyance path 23, and a plurality of conveying rollers 24.

The sheet feed cassette 21 stores a sheet on which an image is formed. For example, sheets such as paper, coated paper, postcard paper, envelopes, and OHP sheets are stored in the sheet feed cassette 21.

The sheet feed portion 22 picks up sheets one by one from the sheet feed cassette 21 and feeds the picked-up sheets to the sheet conveyance path 23.

The sheet conveyance path 23 is a path along which a sheet moves from the sheet feed cassette 21 to the sheet discharge tray 11 through a position of image formation by the image forming portion 3.

The plurality of conveying rollers 24 is provided side by side along the sheet conveyance path 23. Each of the conveying rollers 24 conveys a sheet in a conveyance direction D4 (see FIG. 2) toward the sheet discharge tray 11.

The image forming portion 3 forms an image on a sheet conveyed by the sheet conveying portion 2.

As shown in FIG. 2, the image forming portion 3 includes a photoconductor drum 31, a charging device 32, a laser scanning unit 33, a developing device 34, a toner container 35, a transfer device 36, a cleaning device 37, and a fixing device 38.

The photoconductor drum 31 is provided so as to be rotatable in the arrow direction shown in FIG. 2.

The charging device 32 charges the circumferential surface of the photoconductor drum 31.

The laser scanning unit 33 emits light based on image data to the circumferential surface of the photoconductor drum 31 charged by the charging device 32. The laser scanning unit 33 forms an electrostatic latent image on the circumferential surface of the photoconductor drum 31.

The developing device 34 uses toner to develop the electrostatic latent image formed on the circumferential surface of the photoconductor drum 31. The developing device 34 includes a pair of stirring rollers that stirs a developer including toner and a developing roller that supplies the photoconductor drum 31 with the toner. The pair of stirring rollers and the developing roller are stored in a housing 34A (see FIG. 2). The developing device 34 forms a toner image on the circumferential surface of the photoconductor drum 31.

The toner container 35 supplies the housing 34A of the developing device 34 with toner.

The transfer device 36 transfers the toner image formed by the developing device 34 to a sheet conveyed by the sheet conveying portion 2.

The cleaning device 37 cleans the circumferential surface of the photoconductor drum 31 after the toner image is transferred by the transfer device 36.

The fixing device 38 fixes the toner image transferred to the sheet by the transfer device 36 onto the sheet. The sheet onto which the fixing device 38 fixes the toner image is discharged to the sheet discharge tray 11.

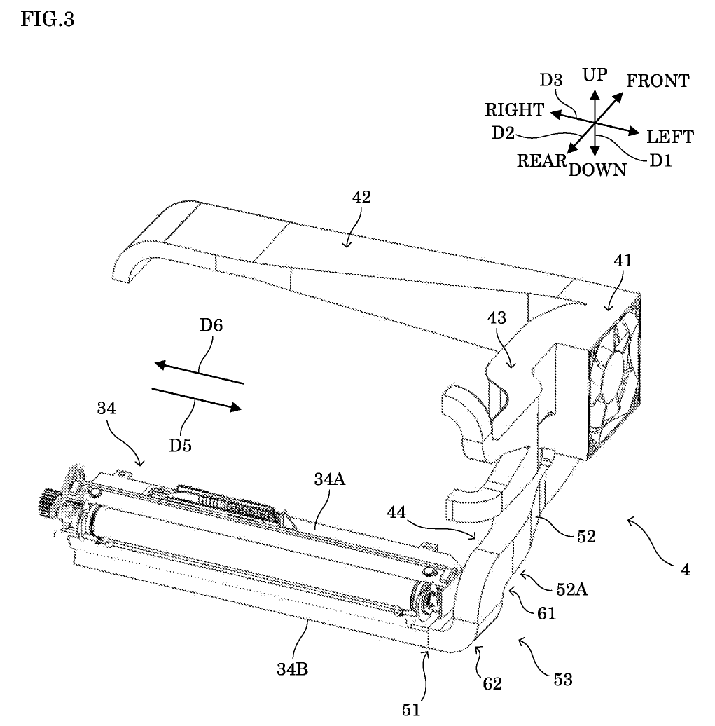

The image forming apparatus 100 performs an image forming operation, thereby generating heat inside the housing 1. Accordingly, the image forming apparatus 100 includes an air-cooling portion 4 (see FIG. 3) that air-cools the inside of the housing 1.

[Configuration of Air-cooling Portion 4] Next, the configuration of the air-cooling portion 4 will be described with reference to FIGS. 1 to 6.

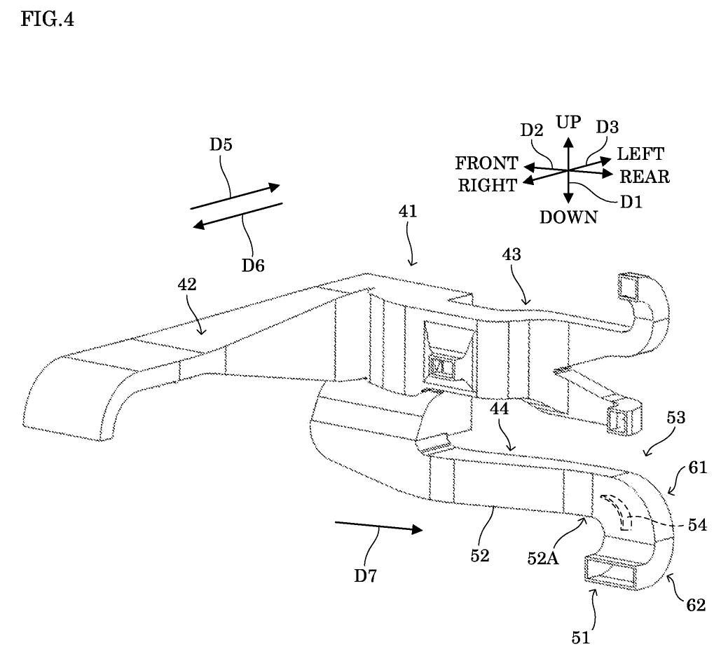

As shown in FIGS. 3 and 4, the air-cooling portion 4 includes an air intake fan 41, a first duct 42, a second duct 43, and a third duct 44.

The air intake fan 41 draws in air from the outside of the housing 1 (see FIG. 1). The air intake fan 41 is provided at the side in a left direction D5 (see FIG. 1) (an example of a first direction according to this disclosure) along a width direction (the same direction as the left-right direction D3) orthogonal to the conveyance direction D4 (see FIG. 2) of a sheet among the four side wall portions of the housing 1. That is, the air intake fan 41 is provided at the left side wall portion 1A. Specifically, the air intake fan 41 is provided to face the air intake port 12 inside the housing 1. As shown in FIG. 3, the air intake fan 41 is an axial flow fan that rotates about the axis along the left-right direction D3.

The first duct 42 guides air drawn in from the outside of the housing 1 by the air intake fan 41 to a first cooling target. The first cooling target is a control substrate of the image forming apparatus 100. The image forming apparatus 100 is provided with the control substrate on the side wall portion located in a right direction D6 (see FIG. 3) among the four side wall portions of the housing 1 (see FIG. 1). The first duct 42 is therefore formed to have a shape that extends in the right direction D6 from the air intake fan 41.

The second duct 43 guides air drawn in from the outside of the housing 1 by the air intake fan 41 to a second cooling target. The second cooling target is the fixing device 38 of the image forming portion 3. In the image forming apparatus 100, the fixing device 38 is disposed rearward of the air intake fan 41. The second duct 43 is therefore formed to have a shape that extends in a rear direction D7 (see FIG. 4) from the air intake fan 41.

The third duct 44 guides air drawn in from the outside of the housing 1 by the air intake fan 41 to a third cooling target. The third cooling target is the developing device 34 of the image forming portion 3. In the image forming apparatus 100, the developing device 34 is disposed rearward of and below the air intake fan 41. The third duct 44 is therefore formed to have a shape that extends in the rear direction D7 (see FIG. 4) from the lower portion of the air intake fan 41. The third duct 44 is an example of a duct according to this disclosure.

As shown in FIGS. 3 and 4, the third duct 44 includes an air blowing port 51, an extending portion 52, and a connecting portion 53.

As shown in FIGS. 3 and 4, the air blowing port 51 is located further in the left direction D5 than the developing device 34 of the image forming portion 3. The air blowing port 51 opens toward the developing device 34 at a position spaced apart from the air intake fan 41 in the direction orthogonal to the left direction D5.

As shown in FIGS. 2 and 3, the developing device 34 includes a cooling duct 34B. As shown in FIG. 2, the cooling duct 34B forms an air path along the bottom surface of the housing 34A and long in the left-right direction D3.

As shown in FIG. 3, the air blowing port 51 is connected to the cooling duct 34B. Air blown from the air blowing port 51 therefore flows in the right direction D6 inside the cooling duct 34B. Airflow generated inside the cooling duct 34B cools the bottom surface of the housing 34A.

The extending portion 52 extends from the air intake fan 41 to the air blowing port 51 along the left side wall portion 1A (see FIG. 1). As shown in FIG. 4, the extending portion 52 extends in a rear direction D7 along a horizontal plane from the lower portion of the air intake fan 41.

The connecting portion 53 connects an extending end 52A (see FIG. 4) of the extending portion 52 and the air blowing port 51.

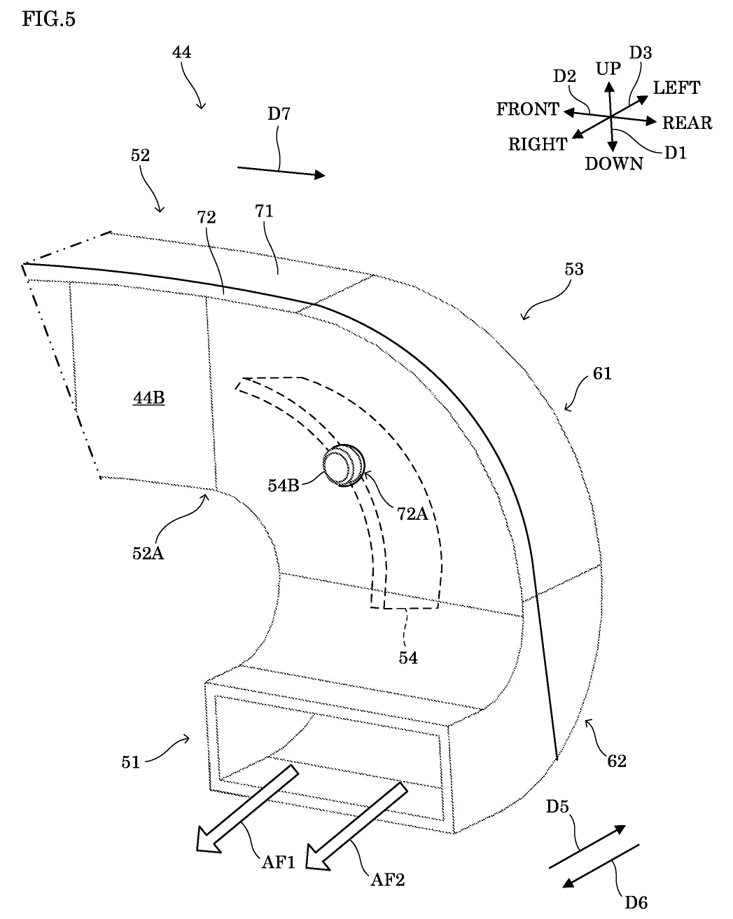

As shown in FIGS. 4 and 5, the connecting portion 53 includes a first curved portion 61 and a second curved portion 62.

As shown in FIGS. 4 and 5, the first curved portion 61 is curved downward along the perpendicular direction from the extending end 52A. For example, the first curved portion 61 is arched downward from the extending end 52A. In addition, the first curved portion 61 may be bent downward from the extending end 52A.

As shown in FIGS. 4 and 5, the second curved portion 62 is curved in the right direction D6 (an example of a second direction according to this disclosure) from the first curved portion 61 and reaches the air blowing port 51. For example, the second curved portion 62 is arched in the right direction D6 from the first curved portion 61 and reaches the air blowing port 51. In addition, the second curved portion 62 may be bent in the right direction D6 from the first curved portion 61 and reach the air blowing port 51.

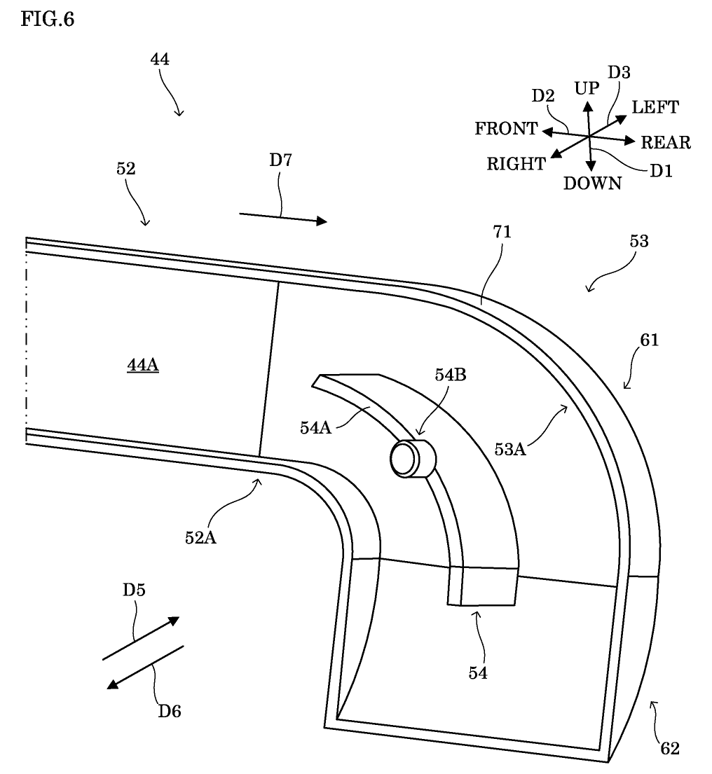

Incidentally, in a configuration in which the connecting portion 53 is included, the wind speed of wind AF2 (see FIG. 5) blown from a downstream portion of the air blowing port 51 in the extending direction (rear direction D7) of the extending portion 52 is greater than the wind speed of wind AF1 (see FIG. 5) blown from an upstream portion of the air blowing port 51 in the extending direction. This is because wind flowing inside the extending portion 52 along the extending direction hits against an inner wall surface 53A (see FIG. 6) of the connecting portion 53 crossing the extending direction to be guided toward the air blowing port 51.

Meanwhile, the wind path in the third duct 44 to the air blowing port 51 along the left direction D5 is increased in length to allow wind blown from the air blowing port 51 to be prevented from being ununiform in wind speed. However, if the wind path in the third duct 44 to the air blowing port 51 along the left direction D5 is increased in length, the housing 1 is increased in size in the width direction.

In contrast, the image forming apparatus 100 according to the embodiment of this disclosure allows the wind blown from the air blowing port 51 to be prevented from being ununiform in wind speed without increasing the housing 1 in size as described below.

Specifically, the third duct 44 includes a guide portion 54 shown in FIGS. 5 and 6.

As shown in FIG. 5, the guide portion 54 is provided in the connecting portion 53. The guide portion 54 guides part of airflow into the connecting portion 53 to the upstream side of the air blowing port 51 in the extending direction of the extending portion 52.

Specifically, as shown in FIGS. 5 and 6, the guide portion 54 is provided in the first curved portion 61.

In addition, as shown in FIG. 6, the guide portion 54 is a rib provided on a first wall portion 44A (see FIG. 6) located in the left direction D5 among a pair of wall portions of the third duct 44 facing each other in the width direction. That is, the guide portion 54 is provided to stand on the first wall portion 44A like a wall. As shown in FIG. 6, the guide portion 54 is formed like a wall that extends in the extending direction and is arched or bent downward. In addition, as shown in FIG. 6, the guide portion 54 is provided to divide the wind path in the first curved portion 61 into two. The guide portion 54 comes into contact with part of airflow (airflow on the bottom side of the extending portion 52) into the connecting portion 53 on a more upstream side than the inner wall surface 53A in the extending direction and guides the airflow to the upstream side of the second curved portion 62 in the extending direction. Additionally, it is sufficient if the shape of the guide portion 54 and the position of the guide portion 54 disposed in the first curved portion 61 are adjusted such that the wind speed of the wind AF1 and the wind speed of the wind AF2 are equal to each other.

Here, the third duct 44 is composed of a second forming member 72 (see FIG. 5) assembled into a first forming member 71 (see FIGS. 5 and 6). FIG. 6 shows the first forming member 71 into which the second forming member 72 has not yet been assembled.

The first forming member 71 forms part of the third duct 44 including the first wall portion 44A of the pair of wall portions of the third duct 44 facing each other in the width direction. The second forming member 72 forms the remaining part of the third duct 44 including a second wall portion 44B (see FIG. 5) of the pair of wall portions different from the first wall portion 44A. As shown in FIGS. 5 and 6, the first forming member 71 forms the part of the third duct 44 located in the left direction D5. In addition, as shown in FIG. 5, the second forming member 72 forms the part of the third duct 44 located in the right direction D6. The second forming member 72 is assembled into the first forming member 71 in the left direction D5.

In addition, the guide portion 54 is provided on the first wall portion 44A and a top portion 54A (see FIG. 6) thereof comes into contact with the second wall portion 44B (see FIG. 5). That is, the guide portion 54 supports the second forming member 72 including the second wall portion 44B from the side of the second wall portion 44B in the left direction D5. This makes it possible to reinforce the third duct 44.

In addition, as shown in FIG. 6, the guide portion 54 includes a projecting portion 54B that projects on the top portion 54A in the right direction D6 which is the direction opposite to the direction (left direction D5) in which the second forming member 72 is assembled into the first forming member 71. For example, the projecting portion 54B projects from the top portion 54A to have a columnar shape.

In addition, the second wall portion 44B of the second forming member 72 includes a fitting hole portion 72A (see FIG. 5) into which the projecting portion 54B is fitted. For example, the fitting hole portion 72A is formed in the shape of a circle having a slightly larger diameter than the diameter of the projecting portion 54B. The projecting portion 54B is inserted to the fitting hole portion 72A when the second forming member 72 is assembled into the first forming member 71. This positions the second forming member 72 with respect to the first forming member 71.

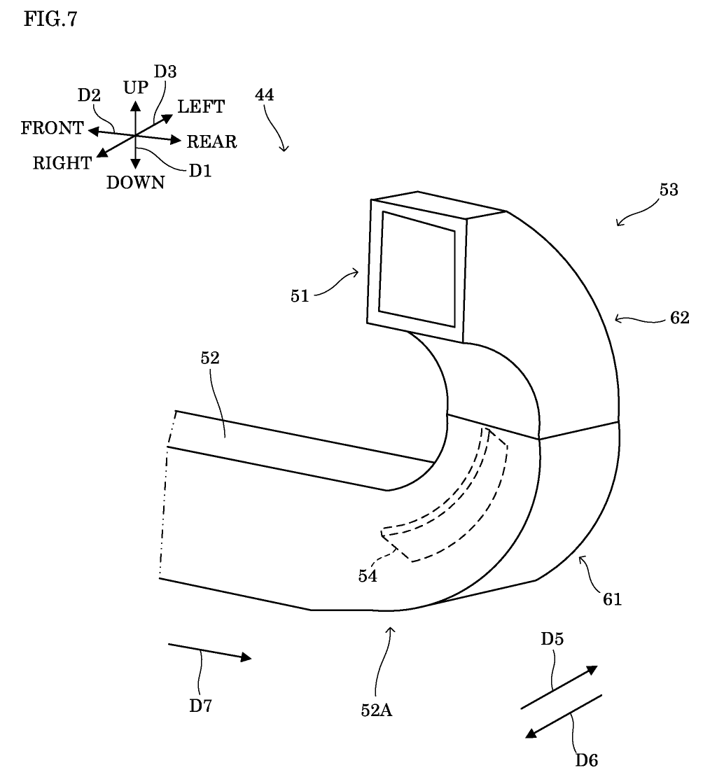

In this way, the image forming apparatus 100 is provided with the guide portion 54 in the connecting portion 53. The guide portion 54 guides part of airflow into the connecting portion 53 to the upstream side of the air blowing port 51 in the extending direction. This allows wind blown from the air blowing port 51 to be prevented from being ununiform in wind speed without increasing the housing 1 in size.

[Modifications] It is noted that the first curved portion 61 may be arched upward along the perpendicular direction from the extending end 52A as shown in FIG. 7. In this case, it is sufficient if the guide portion 54 is formed like a wall that extends in the extending direction and is arched or bent upward.

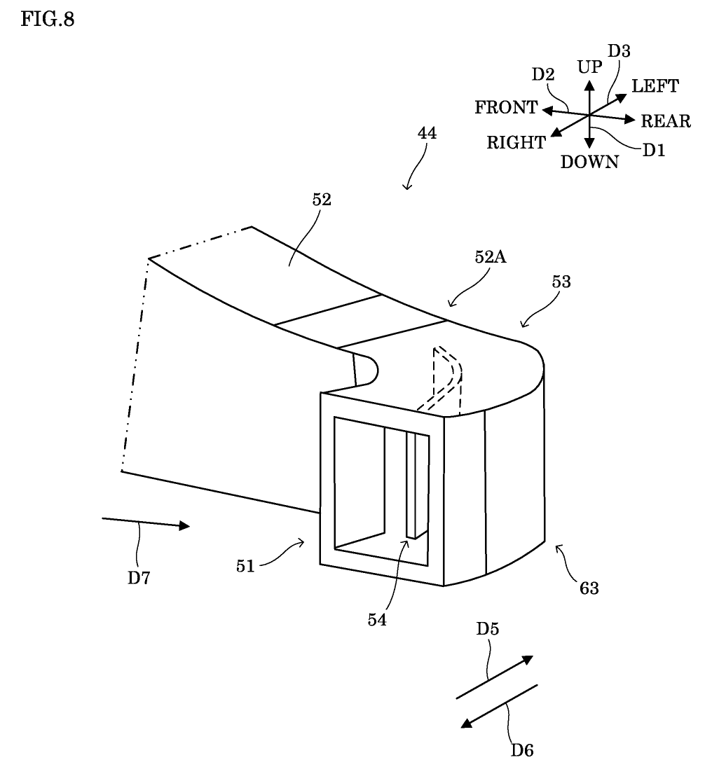

In addition, as shown in FIG. 8, the connecting portion 53 of the third duct 44 may include a third curved portion 63 (an example of a curved portion according to this disclosure) shown in FIG. 8 instead of the first curved portion 61 and the second curved portion 62.

The third curved portion 63 is curved in the right direction D6 from the extending end 52A and reaches the air blowing port 51. For example, the third curved portion 63 is arched in the right direction D6 from the extending end 52A and reaches the air blowing port 51. In addition, the third curved portion 63 may be bent in the right direction D6 from the extending end 52A and reach the air blowing port 51.

In a case where the connecting portion 53 includes the third curved portion 63, the guide portion 54 is provided in the third curved portion 63 as shown in FIG. 8. In addition, the guide portion 54 is a rib provided on the bottom surface portion of the third curved portion 63. In addition, the guide portion 54 is formed like a wall that extends in the extending direction and is arched or bent in the right direction D6.

In addition, this disclosure may be applied to the second duct 43. Furthermore, a target to which the duct according to this disclosure blows wind may be a component of the image forming portion 3 different from the developing device 34 and the fixing device 38.

[Supplementary Notes of Disclosure] The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including: an image forming portion configured to form an image on a conveyed sheet; a housing configured to store the image forming portion; an air intake fan configured to be provided at a side of the housing in a first direction along a width direction orthogonal to a conveyance direction of the sheet; a duct including an air blowing port, an extending portion, and a connecting portion, the air blowing port opening toward the image forming portion in the first direction and spaced apart from the air intake fan in a direction orthogonal to the first direction, the extending portion extending from the air intake fan to the air blowing port along a side wall portion of the housing in the first direction, the connecting portion connecting an extending end of the extending portion and the air blowing port, the duct being configured to guide air drawn in from outside of the housing by the air intake fan to the image forming portion; and a guide portion configured to be provided in the connecting portion and guide part of airflow into the connecting portion to an upstream side of the air blowing port in an extending direction of the extending portion.

### Supplementary Note 2

The image forming apparatus according to Supplementary Note 1, in which the connecting portion includes a first curved portion and a second curved portion, the first curved portion being curved from the extending end along the side wall portion in a direction intersecting the first direction, the second curved portion being curved in the first direction from the first curved portion and reaching the air blowing port, and the guide portion is provided in the first curved portion.

### Supplementary Note 3

The image forming apparatus according to Supplementary Note 1, in which the connecting portion includes a curved portion, the curved portion being curved in the first direction from the extending end and reaching the air blowing port, and the guide portion is provided in the curved portion.

### Supplementary Note 4

The image forming apparatus according to Supplementary Note 2, in which the duct includes a first forming member and a second forming member, the first forming member forming part of the duct including a first wall portion of a pair of wall portions of the duct, the pair of wall portions facing each other in the width direction, the second forming member forming remaining part of the duct including a second wall portion of the pair of wall portions, the second wall portion being different from the first wall portion, the second forming member being configured to be assembled into the first forming member in a direction along the width direction, and the guide portion is a rib that is provided on the first wall portion and a top portion of the guide portion comes into contact with the second wall portion.

### Supplementary Note 5

The image forming apparatus according to Supplementary Note 4, in which the guide portion includes a projecting portion that projects on the top portion in a direction opposite to a direction in which the second forming member is assembled into the first forming member, and the second wall portion includes a fitting hole portion into which the projecting portion is fitted.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to form an image on a conveyed sheet;
a housing configured to store the image forming portion;
an air intake fan configured to be provided at a side of the housing in a first direction along a width direction orthogonal to a conveyance direction of the sheet;
a duct including an air blowing port, an extending portion, and a connecting portion, the air blowing port opening toward the image forming portion in the first direction and spaced apart from the air intake fan in a direction orthogonal to the first direction, the extending portion extending from the air intake fan to the air blowing port along a side wall portion of the housing in the first direction, the connecting portion connecting an extending end of the extending portion and the air blowing port, the duct being configured to guide air drawn in from outside of the housing by the air intake fan to the image forming portion; and
a guide portion configured to be provided in the connecting portion and guide part of airflow into the connecting portion to an upstream side of the air blowing port in an extending direction of the extending portion.

2. The image forming apparatus according to claim 1, wherein
the connecting portion includes a first curved portion and a second curved portion, the first curved portion being curved from the extending end along the side wall portion in a direction intersecting the first direction, the second curved portion being curved in the first direction from the first curved portion and reaching the air blowing port, and
the guide portion is provided in the first curved portion.

3. The image forming apparatus according to claim 1, wherein
the connecting portion includes a curved portion, the curved portion being curved in the first direction from the extending end and reaching the air blowing port, and
the guide portion is provided in the curved portion.

4. The image forming apparatus according to claim 2, wherein
the duct includes a first forming member and a second forming member, the first forming member forming part of the duct including a first wall portion of a pair of wall portions of the duct, the pair of wall portions facing each other in the width direction, the second forming member forming remaining part of the duct including a second wall portion of the pair of wall portions, the second wall portion being different from the first wall portion, the second forming member being configured to be assembled into the first forming member in a direction along the width direction, and
the guide portion is a rib that is provided on the first wall portion and a top portion of the guide portion comes into contact with the second wall portion.

5. The image forming apparatus according to claim 4, wherein
the guide portion includes a projecting portion that projects on the top portion in a direction opposite to a direction in which the second forming member is assembled into the first forming member, and
the second wall portion includes a fitting hole portion into which the projecting portion is fitted.
